(19) United States
(12) Patent Application Publication
(10) Pub. No.: US 2006/0177556 A1
(43) Pub. Date: Aug. 10, 2006

(54) Microwaveable dough, dough product, and manner of preparing a dough product

(76) Inventor: Sara J. Howery, Murray, UT (US)

Correspondence Address: MALLINCKRODT & MALLINCKRODT, P.O. BOX 1219, SANDY, UT, 84091-1219, US

(21) Appl. No.: 11/054,022

(22) Filed: Feb. 9, 2005

(51) Int. Cl. A21D 10/00

(52) U.S. Cl. 426/549

(57) ABSTRACT

Unproofed, frozen, non-yeast dough products are disclosed which upon exposure to microwave energy have characteristics similar to fresh-baked bakery products. A method is provided to make such bakery products without an intervening thawing or proofing step. The frozen dough product is made without multiple leaveners from flour, water, fat, and a protein-starch mixture comprising from about 0.01 baker's % to about 5 baker's % of protein and from about 0.01 baker's % to about 5 baker's % of starch. The starch is preferably a mixture of two starches, one absorbing moisture at ambient mixing temperature and one not absorbing moisture at ambient mixing temperature but having a low bake out temperature. The protein-starch mixture stabilizes moisture migration during microwave cooking.

### BACKGROUND OF THE INVENTION

1. Field

The invention is in the field of frozen dough and bread products formulated specifically for being baked in microwave ovens.

2. State of the Art

Modern consumers of bread products, like consumers of almost every other food product, want high quality with increasingly decreased preparation time. This drastic change in eating habits, a by-product of our fast-paced society, has been dramatic over the last ten years. For years now, this time convenience has been a major factor in the popularity and use of microwave ovens in homes. Surveys in the mid-1990's showed that microwave oven market penetration in the United States exceeded 85%. Such use is even greater now due to a significant increase in the creation of microwaveable products.

This increase in the use of these appliances has proven the need to produce more compatible microwaveable bread and other dough products. The palatability of traditional yeast-raised, wheat-based food products, as well as chemically leavened dough based food products, remains a problem.

Accordingly, there has been an ongoing need in the food art to find additional or alternative techniques for producing frozen baked goods, which will substantially retain their palatability upon baking in microwave appliances. There is a need for a frozen baked good product that can be taken out of the freezer and immediately cooked by microwave energy without the need of defrosting or thawing as a preliminary step to microwave cooking.

While microwave energy will rapidly cook most food products, not all microwave cooked products are delivered in the same quality as is characteristic of the more traditional oven cooked products. Bread and roll products have been known to become unpalatable even after short exposure to microwave energy. Palatable products have acceptable taste and appetizing appearance and aroma. The problems with traditional yeast-raised or chemical leavened breads and rolls being microwaved are that they become crust-hardened and the bread becomes lumpy & soggy.

Texture variations occur in bakery products, whether convection baked or microwave baked. Texture variations are exacerbated by microwaving. It is repeatedly reported that microwave energy causes swift staling and toughness in bakery products.

In U.S. Pat. No. 4,847,104 to Benjamin, proofing is preferably carried out by the manufacturer of frozen dough prior to freezing, adding an expensive and unwanted increased production time. Further, Benjamin provides a frozen dough for conventional oven baking rather than microwaving. The industry is still searching for a frozen dough product which does not need to be proofed prior to freezing nor prior to baking but which still has the palatability of conventional bakery products.

The effect of product moisture content and microwaving was discussed by “Food Technology” in 1971 (25 Food Technology, 921, September 1971). In that article there is a description of the effect of microwaving on bread and a suggestion for reformulation of breads and rolls intended for microwave treatment. The article explains that the rate at which food products absorb microwave energy depends in large measure on their moisture content. Products with high moisture content heat very rapidly in microwave ovens. The problem discussed by the article is the difference in microwave heating time between conventional bread and rolls used for hamburgers, hot dogs or other sandwiches where the bread or rolls have a higher moisture content than do the hamburgers, hot dogs, or other foods filling the bread or rolls. In such instance, the bread or rolls overheat before the filling reaches serving temperature. The article suggests using a “rich” dough formulation for use with microwave ovens which is low in moisture and high in sugar, shortening, and eggs. This lower moisture content results in the bread or rolls absorbing microwaves more slowly and therefore heating more slowly. This allows the bread or rolls to heat similarly as the filling so both reach serving temperature at the same time. However, the use of larger amounts of egg and shortening increases the costs dramatically of the microwavable product, and the “rich” formulation does not solve other problems related to microwaving of bread products. Further, the article points out that frozen products are particularly difficult to heat in microwave ovens because ice crystals absorb microwave energy at 1/25^{th} the rate that water does. Therefore, the article suggests that for cooking frozen products, a microwave oven with pulsating timer mechanism is preferred so that the product is initially heated for a short period of time with microwave energy, then the product is allowed to stand while conductive heat transforms the ice-crystals to water, and then the product is further cooked with an intermittent power cycle set for the most effective and efficient use of alternating microwave and conductive heating. This heating from a frozen state, however, is not discussed for bread products.

The prior art is exemplified by three patents:

U.S. Pat. No. 5,266,345 to Corbin et al. explains that products with high moisture content heat very rapidly in microwave ovens. Food molecules which carry a di-polar electric charge vibrate in the fluctuating microwave electric field. This causes heat of friction within the molecules. Since water molecules carry a di-polar charge, foods with high water content heat very rapidly. Corbin et al. further explain that when starch imbibes water during gelatinization, increased heating rates will occur in those starch locations due to interaction of microwave radiation with the absorbed water. This results in a narrowed tolerance of the starch to textural breakdown. Further, starches have critical moisture levels below which gelatinization will not take place. Gelatinized starch binds less water to its structure, therefore leaving more water free to respond to the microwave field resulting in heat build up in this moisture and undesirable moisture migration. This results in uneven heating of the product. Corbin et al. say that this also prevents dehydration at the surface of the product since the water within the product is continually being converted to steam and migrating out, causing evaporative cooling and condensation at the surface resulting in a wet or soggy surface texture. The uneven heating, unwanted moisture migration, and the wet soggy surface texture results in tough or soggy food products. Corbin et al. teaches that a premix containing egg protein and/or milk protein, mixed with shortening, diminishes staling and toughening during microwave reheating of baked and frozen products. However, significantly increased egg protein and milk protein content add significantly to the cost of bakery goods and since they are both known allergens, it is preferable to avoid adding allergenic ingredients, if not necessary. While Corbin et al. say that their bakery products can be sold in an unbaked state, all but one of Corbin et al.'s examples, that of frozen pie crust, describe supplying the product in prebaked condition for reheating in a microwave oven.

U.S. Pat. Nos. 4,463,020 and 4,560,559 to Ottenburg discuss the preparation of yeast-raised wheat-based food products having improved resistance to deterioration caused by microwave reheating. This improved resistance to deterioration caused by microwave reheating is accomplished by the incorporation of rice flour into the dough, or by the incorporation of rice starch, corn starch, or wheat starch of a particularly small crystal size into the dough. The rice flour or the protein is added to the dough in the amount of from about 5 to about 60 baker's percent. However, Ottenburg teaches that food products should not be in a frozen state when reheated by microwave energy and that his dough product, if frozen, should be defrosted or thawed before being reheated in a microwave oven. Further, Ottenburg's product is prebaked prior to packing and shipping, and only reheated in a microwave oven.

U.S. Pat. No. 4,885,180 to Cochran et al. teaches an improvement in the quality of baked goods after baking and then reheating in a microwave oven by the addition of modified starches in the amount of from 5 to 30 baker's percent. Although Cochran et al. say that their product may be taken from the freezer and placed directly in a microwave oven for reheating without the need to thaw or defrost the product, Cochran et al. deal with reheating previously cooked and then frozen baked products, not the cooking of a raw dough frozen product.

Prior efforts to make microwave cooked dough products less tough have not yielded thoroughly positive results at a reasonable producible price. The desire of the purchasing public for convenience foods has created a need for and is the motivating factor in research for bread products which are not unacceptably chewy and tough after microwave cooking. To provide such a product simply and cost effectively is a real need in the art.

### SUMMARY OF THE INVENTION

The present invention provides a dough and a frozen dough product made therefrom, such as a sweet roll, that can be cooked in a microwave oven to produce a baked product with moderate springiness and without the toughness problems associated with prior microwaved products. The dough of the invention includes a combination of starch and protein to reduce moisture migration in the dough during the microwave baking. This results in more even moisture distribution during baking to provide more even heating. The baked product of the invention has a similar baked shape, volume, and texture as conventionally baked products and has been found to be organolepticlly acceptable to consumers. A frozen raw dough product of the invention can be removed from the freezer and immediately cooked in a microwave oven without any thawing or proofing. The product has a flavor and texture similar to a conventional yeast raised and baked product, but does not include yeast leavening.

The dough of the invention includes about 0.01 to about 5 baker's percent of starch and about 0.01 to about 5 baker's percent of protein to reduce moisture migration in the dough during the microwave baking. The percentages of protein and starch have yielded a dough for microwave cooking which has ideal water absorption due to the dough's hydration capacity. A preferred dough formulation of the invention includes 100 bakers % of flour, such as unbleached white flour; 0.5 to 5 baker's % of salt; 1 to 5 baker's % of sodium bicarbonate; 0.5 to 10 baker's % of sodium acid pyrophosphate; 0.5 to 5 baker's % of nonfat dry milk; 0.5 to 20 baker's % of sweetener, such as crystalline sucrose; 0.5 to 5 baker's % of protein; 0.03 to 5 baker's % of starch; 0.05 to 60 baker's % of fat, such as all purpose shortening; and 25 to75 baker's % of water. The ingredients are mixed in normal manner and the resulting dough thereafter maintains palatable texture, proofing, and form.

In its preferred form, the dough of the invention includes between about 0.1 to about 3 baker's percent of a mixture of two different high amylopectin starches in combination with about 0.1 to about 3 baker's percent of protein in the form of vital wheat gluten. The starch mixture includes a starch which absorbs liquid at ambient dough mixing temperature, i.e., the starch absorbs liquid as the dough is mixed, and a starch which does not absorb liquid at ambient mixing temperature, but at a low baking temperature such as about 90° F. to about 150° F. The starch that absorbs liquid at ambient mixing temperature will generally be a pregelatinized starch, while the starch that does not absorb liquid until reaching a low baking temperature is generally referred to as a starch with a low bake out temperature. The low tendency of amylopectin to retrograde provides proper texture cell structure. One problem with frozen foods is that freezing of foods generally causes syneresis. This is a loss of liquid from the frozen product and the resulting contraction of the frozen product or components thereof. The starch that absorbs liquid at ambient mixing temperature tends to hold this liquid when frozen significantly reducing syneresis of the frozen product and maintaining the distribution of liquid in the frozen product. However, the proportions of starch are chosen so that significant free liquid remains in the product unbound by the pregelatinized starch. Free moisture as the product begins to bake is important for the proper texture development. The starch with low cook out temperature absorbs and holds some of this free liquid during baking of the product to further maintain liquid distribution in the product as it bakes thereby significantly reducing liquid migration during microwaving of the product. The gluten also absorbs liquid to lend elasticity and cohesion to the dough, thereby improving texture and strength of the dough.

### THE DRAWINGS

In the accompanying drawing:

FIG. 1 is a graphical representation of the results of testing of four formulations of the invention, each with a different starch mixture.

### DETAILED DESCRIPTION

The present invention generally relates to a frozen dough and microwavable bakery products made from that dough and to a method of making microwavable bakery products. More specifically, the present invention relates to a microwavable frozen dough or bakery product that is transformed into a fresh-baked bakery product by application of microwave energy without any intervening thawing or proofing.

This is brought about by the incorporation into the dough of an effective amount of protein in combination with an effective amount of starch. The protein is preferably a cereal protein. Most preferably the protein is vital wheat gluten. The starch is preferably derived from corn, rice, potato, barley, rye, tapioca or wheat. Most preferably the starch is a combination of two or more modified high amylopectin corn starches, one being pregelatinized and the other having a low cook out temperature.

It has been discovered that incorporation into the dough of an effective amount of protein in combination with an effective amount of starch in accordance with the present invention produces a microwavable dough that may be baked by application of microwave energy to form a fresh-baked bakery product. Additionally, it has been discovered that incorporation into the dough of an effective amount of protein in combination with an effective amount of starch in accordance with the present invention will reduce or prevent moisture migration in the dough prior to, during, and after the application of microwave energy.

The protein used in the dough of the invention is preferably incorporated into the dough at a level of from about 0.01 baker's % to about 5 baker's %, most preferably from about 0.1 baker's % to about 3 baker's %. The starch used in the dough of the invention is preferably incorporated into the dough at a level of from about 0.01 baker's % to about 5 baker's %, most preferably from about 0.1 baker's % to about 3 baker's %. All percentages refer to baker's weight percents wherein the weight of each non-flour ingredient contained in the dough formulation is expressed as a weight percent of the flour ingredient of the formulation.

The term “vital wheat gluten” as used herein refers to the wheat protein extracted from wheat starches. The level of gluten is critical. Testing revealed that too high a level of gluten results in a dry, decreased volume product. Further, too low a level of gluten leaves the product too soft without sufficient structure. Typically, vital wheat gluten is a powder containing 75% protein. The preferred vital wheat gluten rapidly absorbs about twice its weight in water to lend elasticity and cohesion, thereby improving texture and strength of the inventive dough. The preferred vital wheat gluten used in the inventive dough is available commercially under the trade name Gluvital 21000 from Cerestar USA, Inc., Hammond, Ind.

The term “high amylopectin starch” as used herein refers to a single starch or a mixture of starches wherein about 75% or more by weight of the starch content is amylopectin.

Further, the preferred high amylopectin starches are chemically modified in order to protect them from heat, acidity, and shear. Additionally, the preferred modified high amylopectin starches are hydroxypropylated to increase their water-holding capacity. As indicated, it is preferred that the starch used be a combination of at least two starches. One of the preferred hydroxypropylated starches used in the mix for the inventive dough is pregelatinized to help prevent syneresis of the dough while in the freezer. The pregelatinized starch absorbs liquid at ambient dough mixing temperature, i.e., the starch absorbs liquid as the dough is mixed. The ambient mixing temperature for the dough will generally be held at about 70 degrees F or below. This pregelatinized starch will hold the absorbed liquid when the dough is frozen, thereby significantly reducing syneresis of the frozen product and maintaining the distribution of liquid in the frozen product. A second of the preferred hydroxypropylated starches used in the mix for the inventive dough is a starch having a low cook out temperature. This means that the starch does not absorb liquid at the ambient mixing temperature of the dough, but at a higher temperature. It is preferred, however, that this higher temperature be a relatively low temperature, preferably in the range of about 90° F. and about 150° F., and preferably near 100° F. The temperature at which this starch starts to absorb liquid needs to be above the temperature of mixing of the dough so it does not absorb significant amounts of liquid during mixing. This will allow the starch to start absorbing liquid as the product is baked and the dough reaches the bake out temperature. This further maintains liquid distribution in the product as it bakes thereby significantly reducing liquid migration during microwaving of the product. The preferred high amylopectin starches include the modified waxy maize starches available commercially under the trade names LoTemp 452 and Tender-jel 434 from A. E. Staley, Decatur, Ill. LoTemp 452 is hydroxypropylated and has a low cook out temperature of about 125° F. Tender-jel 434 is also hydroxypropylated and is pregelatinized.

It is preferred that the mixture of the at least two starches include at least about 0.01 baker's % of each of the starches so that the mixture of starches makes up between at least about 0.02 baker's % and about 5 baker's % of the dough.

The term “flour” as used herein refers to any flour which may include but is not limited to that derived from wheat, rye, corn, rice, potato, barley, buckwheat, triticale, rice, amaranth, soy or any combination of these. The most typical flour used in baking is wheat flour with a protein content ranging from about 7% to about 14%. Few flours used in baking, however, have the high 14% level of protein. Any flour material that is suitable for use in baking may be used in the present invention. The preferred flour used in the preparation of the inventive dough is wheat flour containing from about 9% to about 14% by weight of protein.

The protein in flour is generally wheat gluten. Thus, the protein content of the flour has an affect on the amount of vital wheat gluten needed to be added to the dough of the invention. It has generally been found that the dough of the invention should have a gluten content of between about 12% to about 18% with a minimum gluten content of about 14% preferred. Thus, if the flour used has a gluten content of over about 12%, it is not necessary to add the vital wheat gluten to the dough, although it is preferred to have at least about 14% wheat gluten. The amount of wheat gluten added should generally be sufficient to bring the total wheat gluten content of the dough to above about 12% and preferably to about 14%.

The preferred embodiments of the dough of the invention contain fat. The amount of fat ranges from 5 to 60 bakers %, more preferably from 10 to 30 bakers %. The term “fat” as used herein refers to any oil or higher melting fat which is suitable for use in baked products. Shortenings contribute flavor and texture to the baked goods. The fat used may be liquid, solid, plastic or semi-fluid. Glyceride shortenings obtained from animal or vegetable fats which may include but is not limited to corn oil, soybean oil, cottonseed oil, rapeseed oil, coconut oil, olive oil, peanut oil, palm oil, sunflower oil, lard or any combination of these are suitable for use herein. The preferred fat used in the preparation of the inventive dough is partially hydrogenated soybean oil available from Golden Foods, Golden Brands, Louisville, Ky.

In accordance with the invention, the inventive dough will typically include a chemical leavening agent. This may be a carbonate factor such as calcium bicarbonate, potassium bicarbonate, or sodium bicarbonate, and a leavening acid in an amount appropriate to neutralize the carbonate factor. Leavening acid used in the preparation of the inventive dough may include but is not limited to monocalcium phosphate, anhydrous monocalcium phosphate, dicalcium phosphate, sodium acid pyrophosphate, sodium aluminum phosphate, sodium aluminum sulfate, calcium acid pyrophosphate, glucono delta lactone, potassium hydrogen tartrate, calcium sulfate and fumeric acid.

The inventive dough also will typically include a sweetening agent which may include but is not limited to sucrose, dextrose, fructose, corn syrup, high fructose corn syrup, invert sugar, maltodextrin, maltose, lactose, honey, molasses, lactitol, maltitol, xylitol, tagatose, sorbitol, erythritol, mannitol, trehalose, isomalt, sucralose, acesulfame-potassium, cyclamate, neotame, saccharin, aspartame of any combination of these.

Other preferred ingredients included in the inventive dough are salt and a dairy ingredient. Dairy ingredients used in the preparation of the inventive dough may include but are not limited to whey, milk, nonfat dry milk, and casein.

Testing was undertaken to locate and overcome the cause of toughening of freezer to oven micro-waved dough. It has been found in the industry that frozen uncooked dough has a higher moisture content than pre-baked dough, causing increased moisture migration. This adversely affects performance of dough products when exposed to microwave energy. Testing included the interactions of protein with various starches to prevent this microwave toughening.

Dough was made using four different mixtures of starch. The dough was made into sweet rolls and the raw dough sweet rolls frozen. Frozen sweet rolls were taken from the freezer and baked without thawing for about one minute in a microwave oven at the high power setting.

The four formulas used identical percentages of the following ingredients: unbleached enriched flour, water, sugar, shortening, nonfat dry milk, gluten, salt, and leavening. For each formula, the dough was mixed, processed, and frozen in the same way. The variable tested was the starch mixture. The different starch mixtures are set forth below:

| | |
|---|---|
| Formula A | Starch 1 - pregelatinized high amylopectin |
| | Starch 2 - hydroxypropylated high amylopectin |
| Formula B | Starch 1 - pregelatinized high amylopectin |
| | Starch 2 - pregelatinized and hydroxypropylated |
| | high amylopectin |
| Formula C | Starch 1 - hydroxypropylated high amylopectin |
| | Starch 2 - pregelatinized and hydroxypropylated |
| | high amylopectin |
| Formula D | Starch 1 - hydroxypropylated high amylopectin |
| | Starch 2 - high amylose |

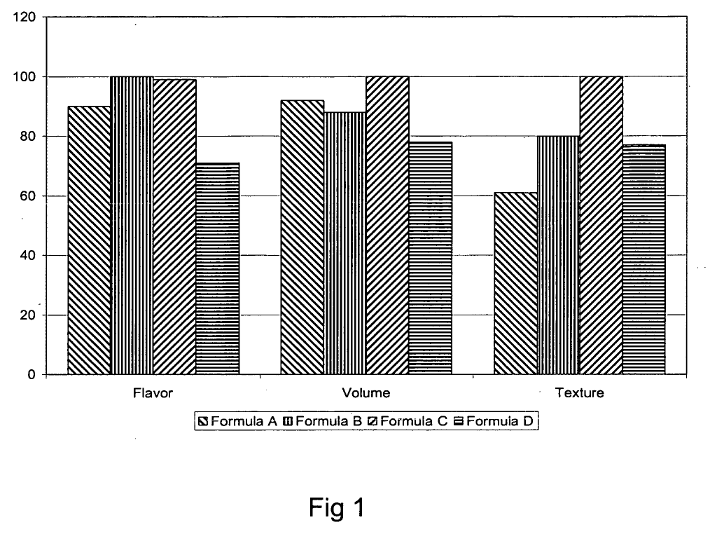

Each test sample was graded on visual and organoleptic performance. FIG. 1 shows the results of such testing. FIG. 1 shows how sweet rolls made with each of the four formulations were rated in the area of flavor, volume, and texture. The volume was measured in centimeters with calipers. Flavor and texture were rated subjectively (organoleptically) on a scale of 1 to 5, with 5 being the best. These ratings were converted to a rating scale of 0 to 100, a rating of 100 being “ideal” and 0 being “unsatisfactory.”

All of the formulas tested produced an edible baked sweet roll. However, formula C produced a very good product in all areas tested. It out-performed the other mixtures significantly in the three test areas, being rated essentially ideal in all three areas. Formula D produced a marginal product, with the other formulas producing in-between products.

Preferred doughs within formula C, include ingredients in the following ranges: 100 bakers % of unbleached white flour; 0.5 to 5 baker's % of salt; 1 to 5 baker's % of sodium bicarbonate; 0.5 to 10 baker's % of sodium acid pyrophosphate; 0.5 to 5 baker's % of nonfat dry milk; 0.5 to 20 baker's % of crystalline sucrose; 0.5 to 5 baker's % of vital wheat gluten; 0.03 to 5 baker's % of pregelatinized high amylopectin starch; 0.03 to 5 baker's % of low temperature high amylopectin starch; 0.05 to 60 baker's % of fat in the form of all purpose shortening and 25 to75 baker's % of water. A particularly satisfactory formula is set forth in the following table:

| Ingredient | Bakers Percent |
|---|---|
| Unbleached White Flour | 100 |
| Salt | 1 |
| Sodium Bicarbonate | 2.15 |
| Sodium Acid Pyrophosphate | 2.99 |
| Nonfat Dry Milk | 2.7 |
| Crystalline Sucrose | 6 |
| Vital Wheat Gluten | .68 |
| High Amylopectin Starch (pregelatinized) | 0.8 |
| High Amylopectin Starch (low temperature) | 0.5 |
| All-purpose Shortening | 20 |
| Water | 59 |

To produce the dough of the present invention, flour, salt, sodium bicarbonate, sodium acid pyrophosphate, nonfat dry milk, sucrose, vital wheat gluten, and high amylopectin starches are first combined and mixed for 30 seconds on low speed. Low speed mixers generally mix at about 76 to about 78 RPM. Next the shortening is added and mixed on high speed for 30 seconds. High speed mixers generally mix at about 250 to about 500 RPM. Then, the water is added and mixed on slow speed for 60 seconds and on high speed for 180 seconds.

In one preferred embodiment of the invention, the dough is sheeted to a thickness of about 0.25 inches. Next, a filling is applied to the sheeted dough and the dough is rolled to create a tube of filled dough with a number of swirls. The dough tube is then cut into individual rolls weighing approximately 2 ounces and which, after cutting, are approximately 1 inch thick, 2.8 inches long, and 1.7 inches wide. Each roll has a spirally rolled strip of dough forming dough layers with filling between the layers.

The cutting may be accomplished by hand or mechanically by processing equipment adjusted to automatically cut the rolled product into proper size. Throughout the process, the dough is maintained at an appropriate cool temperature below the bake out temperature of the low bake out temperature starch, such as at or below about 70° F. A cooling equilibrium is maintained throughout machining to ensure that the dough is processed consistently and appropriately in the subsequent steps. The process will also maintain the desired size and shape of the product. Throughout the dough sheeting process, adjustments are made to maintain the proper dimensions of the product and maintain high product quality and texture.

In another preferred embodiment of the invention, the dough is sheeted to a thickness of about 3/16 ths inch. Next, a filling is applied to portions of the sheeted dough which is then cut into individual pieces which in turn are folded and sealed to form a turnover or ravioli type product. The folding forms two layers of dough with filling sealed between the two layers. The individual filled dough pieces weigh approximately 2 ounces and are approximately 1 inch thick and 2 inches square.

In order to obtain browning in the microwave oven, a browning solution such as Maillose is applied to the filled, rolled, and cut or folded dough. The raw dough product is then frozen without proofing or baking.

Various fillings may be used in filled products. Ready to spread commercially available fillings such as apple, strawberry, raspberry, peach, pineapple, apricot, mango, lemon, cream cheese, cherry, peanut butter, chocolate, marshmallow, or dulce de leche fillings, or any combination of these, may be used. A currently preferred filling for use with the dough of the present invention contains the following:

| Ingredient | Bakers Percent |
|---|---|
| Crystalline sucrose | 100 |
| Table margarine | 50 |
| Cinnamon | 8 |

The filling ingredients are combined and mixed for 150 seconds on slow speed and approximately 150 seconds on fast. The filling product above is mixed to incorporate the cinnamon and sugar into the margarine so that pleasing flavor and aroma are achieved while deterioration of the dough is minimized.

After forming the desired product, the final two steps for production of a baked dough product of the invention are that the product may be frozen and then the frozen product may be microwave cooked by normal microwave energy. The invention may be repeatedly frozen without loss of palatability. The amylopectin content of the invention ensures fluid stability during the freezing phase and a similar stability during and after microwave cooking. Storage of the frozen product may be done at temperatures ranging in the normal home freezer ranges. These are preferably temperatures below about 0° F. The frozen product making up the invention may be stored for periods of up to about six months. However, frozen foods lose quality when held at temperatures above 0° F. Generally, for every 5 degrees above 0° F., the storage life of food is cut in half. Microwave cooking time will vary with the product and with the microwave oven used. Generally, for a single, frozen rolled sweet roll product as described above, cooking on high for from fifty-five to seventy seconds will provide a freshly baked sweet roll which simulates a freshly conventionally baked similar sweet roll. By “simulating a conventionally baked similar sweet roll” is meant that the microwave baked sweet roll will compare very favorably with the shape, flavor, and texture of a conventionally made and baked similar type of sweet roll. Similarly, reference to simulating a freshly conventionally baked dough product is meant that the microwave baked dough product of the invention will compare very favorably with the shape, flavor, and texture of a conventionally made and baked similar type of dough product.

A product of the invention does not need proofing or thawing between the freezer and the microwave. Once microwave cooked, the product has the appearance and taste of traditional baked products. However, if thawing or proofing occur, the palatability of the invention is not diminished.

Whereas this invention is here illustrated and described with specific reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

1. An unproofed, frozen, microwaveable dough, comprising:
flour, water, and fat; and
a protein-starch mixture comprising from about 0.01 baker's % to about 5 baker's % of protein and about 0.01 baker's % to about 5 baker's % of starch.

2. The dough of claim 1, wherein the protein is cereal protein.

3. The dough of claim 2, wherein the cereal protein is vital wheat gluten.

4. The dough of claim 3, wherein the amount of vital wheat gluten ranges from about 0.1 baker's % to about 5 baker's %.

5. The dough of claim 1, wherein the starch is derived from corn, rice, potato, barley, rye, tapioca or wheat.

6. The dough of claim 5, wherein the starch comprises one or more high amylopectin starches.

7. The dough of claim 6, wherein the high amylopectin starch is derived from waxy corn starch.

8. The dough of claim 7, wherein the high amylopectin starch comprises a combination of two high amylopectin starches.

9. The dough of claim 8, wherein one high amylopectin starch is a pregelatinized, modified waxy corn starch capable of imbibing relatively large amounts of water.

10. The dough of claim 9, wherein the amount of high amylopectin starch ranges from about 0.1 baker's % to about 3 baker's %.

11. The dough of claim 8, wherein one high amylopectin starch is a modified, waxy corn starch capable of imbibing relatively large amounts of water and has a low cook out temperature.

12. The dough of claim 11, wherein the amount of high amylopectin starch ranges from about 0.1 baker's % to about 3 baker's %.

13. An unproofed, frozen, microwaveable dough product, formed of a dough comprising:
flour, water, fat, and a chemical leavening agent; and
a gluten-starch mixture comprising from about 0.01 baker's % to about 5 baker's % of gluten and from about 0.01 baker's % to about 5 baker's % of starch;
wherein said dough product, when taken frozen from a freezer and cooked in a microwave oven with no intervening thawing or proofing, forms a baked dough product which simulates a freshly conventionally baked dough product.

14. The dough product of claim 13, wherein the gluten is vital wheat gluten.

15. The dough product of claim 14, wherein the amount of vital wheat gluten ranges from about 0.1 baker's % to about 5 baker's %.

16. The dough product of claim 13, wherein the starch comprises one or more high amylopectin starches.

17. The dough product of claim 16, wherein the high amylopectin starch is derived from waxy corn starch.

18. The dough product of claim 17, wherein the high amylopectin starch comprises a combination of two high amylopectin starches.

19. The dough product of claim 18, wherein one high amylopectin starch is a pregelatinized, modified waxy corn starch capable of imbibing relatively large amounts of water.

20. The dough product of claim 19, wherein the amount of high amylopectin starch ranges from about 0.1 baker's % to about 3 baker's %.

21. The dough product of claim 18, wherein one high amylopectin starch is a modified, waxy corn starch capable of imbibing relatively large amounts of water and has a tow cook out temperature.

22. The dough product of claim 21, wherein the amount of high amylopectin starch ranges from about 0.1 baker's % to about 3 baker's %.

23. The dough product of claim 13, wherein the dough product is a sweet roll in the form of a spirally rolled strip of dough forming dough layers with filling between the layers.

24. The dough product of claim 13, wherein the dough product is a sweet roll in the form of a sheet of dough folded over on itself to form two layers of dough, and additionally including a filling between the dough layers.

25. An unproofed, frozen, microwaveable dough comprising; flour, water, protein, and fat; and
from about 0.01 baker's % to about 5 baker's % of a mixture of a high amylopectin starch having a low cook out temperature and a pregelatinized high amylopectin starch which absorbs water at ambient dough mixing temperature.

26. The dough of claim 25, wherein the pregelatinized high amylopectin starch makes up between about 0.01 baker's % and about 5 baker's % percent of the dough.

27. The dough of claim 26, wherein each of the high amylopectin starches is hydroxypropylated.

28. The dough of claim 25, wherein each of the high amylopectin starches is hydroxypropylated.

29. An unproofed, frozen, microwaveable dough, comprising:
flour, water, fat, and protein, wherein the dough has a total protein content of between about 12 baker's % to about 18 baker's %; and
starch comprising from about 0.01 baker's % to about 5 baker's %.

30. An unproofed, frozen, microwaveable dough according to claim 29, wherein the dough has a total protein content of at least about 14 baker's %.

31. A method of preparing a frozen, microwaveable dough product comprising the steps of:
obtaining an unproofed dough comprising flour, water, fat, and a protein-starch mixture comprising from about 0.01 baker's % to about 5 baker's % of protein and from about 0.01 baker's % to about 5 baker's % of starch;
forming the unproofed dough into the desired dough product;
and freezing the unproofed dough product to form a frozen dough product that can be cooked in a microwave oven with no intervening thawing or proofing.

32. A method of preparing a frozen, microwaveable dough product according to claim 31, wherein the step of obtaining an unproofed dough comprises obtaining an unproofed dough comprising flour, water, fat, and a protein-starch mixture comprising from about 0.01 baker's % to about 5 baker's % of protein, from about 0.01 baker's % to about 5 baker's % of a high amylopectin starch having a low cook out temperature, and from about 0.01 baker's % to about 5 baker's % of a pregelatinized high amylopectin starch which absorbs water at ambient dough mixing temperature.

33. A method of preparing a frozen, microwaveable dough product according to claim 32, wherein the high amylopectin starches are hydroxypropylated.

34. A method of preparing a baked dough product in a microwave oven, which product simulates a freshly conventionally baked dough product, comprising the steps of: obtaining an unproofed, frozen microwaveable dough product in which the dough comprises flour, water, fat, and a protein-starch mixture comprising from about 0.01 baker's % to about 5 baker's % of gluten and from about 0.01 baker's % to about 5 baker's % of starch;
placing the frozen and unproofed dough product into a microwave oven with no intervening thawing or proofing; and
microwaving the frozen and unproofed dough product for a time period sufficient to produce a microwave baked dough product simulating a freshly conventionally baked dough product.
